(19) United States
(12) Patent Application Publication
(10) Pub. No.: US 2009/0060045 A1
(43) Pub. Date: Mar. 5, 2009

(54) MOVING PICTURE ENCODING APPARATUS AND MOVING PICTURE ENCODING METHOD

(75) Inventor: Tsuyoshi Tateno, Kawasaki-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/190,126

(22) Filed: Aug. 12, 2008

(30) Foreign Application Priority Data
Aug. 29, 2007 (JP) 2007-222573

(51) Int. Cl. H04N 7/32

(52) U.S. Cl. 375/240.16; 375/E07.125

(57) ABSTRACT

According to one embodiment, a reference macroblock determination module determines, with respect to each of the peripheral macroblocks corresponding to the to-be-encoded macroblock, whether the macroblock is an encoded macroblock or not, determines, if the macroblock is the encoded macroblock, the macroblock as a reference macroblock which is to be used in order to determine a prediction mode candidate of the to-be-encoded macroblock, and to determine, if the macroblock is a non-encoded macroblock, an encoded macroblock, which is present in an encoded picture immediately preceding the to-be-encoded picture and which is present at the same spatial position as the macroblock, as the reference macroblock. A reference macroblock with a lowest cost is selected from these reference macroblocks, and the same prediction mode as the prediction mode of the selected reference macroblock is determined as a prediction mode candidate.

### CROSS-REFERENCE TO RELATED APPLICATIONS

This application is based upon and claims the benefit of priority from Japanese Patent Application No. 2007-222573, filed Aug. 29, 2007, the entire contents of which are incorporated herein by reference.

### BACKGROUND

1. Field

One embodiment of the present invention relates to a moving picture encoding apparatus and a moving picture encoding method for encoding a moving picture signal by selectively using a plurality of prediction modes.

2. Description of the Related Art

In recent years, personal computers, which include software encoders for encoding moving pictures by software, have begun to gain in popularity. In addition, attention has recently been paid to the H.264/AVC (Advanced Video Coding) standard as a next-generation moving picture compression-encoding technique. The H.264/AVC standard is a compression-encoding technique with a higher efficiency than conventional compression-encoding techniques such as MPEG-2 and MPEG-4.

In inter-frame prediction coding of the H.264/AVC standard, use can be made of a plurality of prediction modes with different prediction block shapes, such as 16×16 pixels, 16×8 pixels, 8×16 pixels, and 8×8 pixels. In addition, in the case where the prediction block shape is 8×8 pixels or more, the block shapes of 4×4 pixels and 8×8 pixels can also be selectively used in orthogonal transformation. In intra-frame prediction coding of the H.264/AVC standard, nine prediction directions can be selected for prediction block shapes, such as 4×4 pixels and 8×8 pixels, and four prediction directions can be selected for prediction block shapes, such as 16×16 pixels.

As described above, in the H.264/AVC standard, an improvement of the prediction efficiency can be realized by increasing the number of usable prediction modes.

However, in the encoding process corresponding to the H.264/AVC standard, a greater processing amount is required than in the conventional compression-encoding techniques such as MPEG-2 and MPEG-4. In particular, a large amount of processing is required in a prediction mode determination process for determining an optimal prediction mode from a plurality of prediction modes with respect to each of macroblocks.

Under the circumstances, there have been proposed techniques for reducing the amount of processing that is necessary for moving picture encoding.

Jpn. Pat. Appln. KOKAI Publication No. 2006-246431, for instance, discloses a technique of determining an intra-prediction mode, which is to be applied to a to-be-encoded block, in accordance with an intra-prediction mode of an already encoded neighboring block.

However, as described above, in the H.264/AVC standard, there are a plurality of prediction modes for inter-frame prediction coding, as well as prediction modes for intra-frame prediction coding. Thus, in order to reduce the amount of processing of the encoding process according to the H.264/AVC standard, it is necessary to efficiently determine one prediction mode, which is to be applied, from a plurality of prediction modes including prediction modes for inter-frame prediction coding and prediction modes for intra-frame prediction coding.

Besides, if the intra-prediction mode of a to-be-encoded block is merely determined from the intra-prediction mode of the already encoded neighboring block, it is highly possible that the intra-prediction mode, which is suited to the to-be-encoded block, cannot be selected, and this leads to degradation in image quality.

It is necessary, therefore, to realize a novel technique which can reduce the processing amount that is needed for prediction mode determination, while suppressing a decrease in image quality.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing an example of the structure of a moving picture encoding apparatus according to an embodiment of the present invention;

FIG. 2 is an exemplary block diagram showing the functional structure of an encoder which is realized by a video encoder application which is used in the moving picture encoding apparatus according to the embodiment;

FIG. 3 is an exemplary block diagram for describing the function of a prediction mode determination unit which is provided in the moving picture encoding apparatus according to the embodiment;

FIG. 4 shows examples of the order of encoding of macroblocks in the moving picture encoding apparatus according to the embodiment;

FIG. 5 shows a relationship between a to-be-encoded macroblock and reference macroblocks in a prediction mode determination process which is executed by the moving picture encoding apparatus according to the embodiment;

FIG. 6 is an exemplary flow chart illustrating the procedure of the prediction mode determination process which is executed by the moving picture encoding apparatus according to the embodiment;

FIG. 7 is an exemplary flow chart illustrating the procedures of a reference macroblock determination process and a prediction mode candidate determination process, which are executed by the moving picture encoding apparatus according to the embodiment; and

FIG. 8 is an exemplary flow chart illustrating the procedure of a process of selecting a reference macroblock by making use of a weighted cost, which is executed by the moving picture encoding apparatus according to the embodiment.

### DETAILED DESCRIPTION

Various embodiments according to the invention will be described hereinafter with reference to the accompanying drawings. In general, according to one embodiment of the invention, there is provided a moving picture encoding apparatus which divides each of pictures of a to-be-encoded moving picture signal into a plurality of macroblocks, selects, with respect to each of the macroblocks, one prediction mode from a plurality of prediction modes including prediction modes for inter-frame prediction coding and prediction modes for intra-frame prediction coding, and encodes the macroblock by the selected prediction mode, comprising: a peripheral macroblock specifying module configured to specify a plurality of peripheral macroblocks which correspond to a to-be-encoded macroblock, the plurality of peripheral macroblocks being a plurality of macroblocks which are present in a to-be-encoded picture in which the to-be-encoded macroblock is present, and which neighbor the to-be-encoded macroblock in such a manner as to surround the to-be-encoded macroblock; a reference macroblock determination module configured to determine, with respect to each of the macroblocks in the specified plural macroblocks, whether the macroblock is an encoded macroblock or not, to determine, if the macroblock is the encoded macroblock, the macroblock as a reference macroblock which is to be used in order to determine a prediction mode candidate of the to-be-encoded macroblock, and to determine, if the macroblock is a non-encoded macroblock, an encoded macroblock, which is present in an encoded picture immediately preceding the to-be-encoded picture and which is present at the same spatial position as the macroblock, as the reference macroblock, thereby determining a plurality of reference macroblocks which correspond to the plural peripheral macroblocks; a prediction mode candidate determination module configured to refer to a cost which indicate a code amount occurring in encoding of each of the determined plural reference macroblocks, thereby selecting a reference macroblock with a lowest cost of the plural reference blocks, and determining a prediction mode, which is used in the encoding of the selected reference macroblock, as a prediction mode candidate which is to be applied to the to-be-encoded macroblock; a cost calculation module configured to calculate a cost which is indicative of a code amount occurring in a case where the to-be-encoded macroblock is encoded by the determined prediction mode candidate; a first prediction mode determination module configured to determine, if the calculated cost is equal to or less than the cost of the selected reference macroblock, the determined prediction mode candidate as a prediction mode which is to be applied to the to-be-encoded macroblock; and a second prediction mode determination module configured to calculate, if the calculated encoding cost is greater than the encoding cost of the selected macroblock, costs indicative of code amounts which occur in cases where the to-be-encoded macroblock is encoded by prediction modes other than the prediction mode candidate, and to determine a prediction mode with a lowest cost of the prediction modes as a prediction mode which is to be applied to the to-be-encoded macroblock.

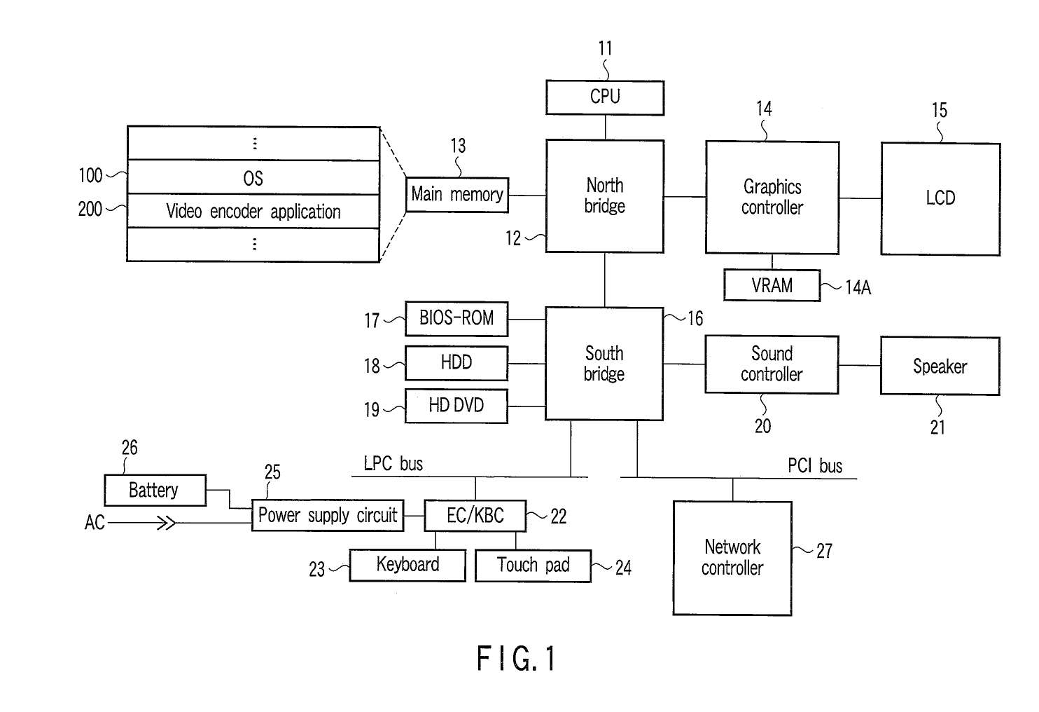

FIG. 1 shows an example of the structure of a moving picture encoding apparatus according to an embodiment of the present invention. This moving picture encoding apparatus is realized, for example, by a computer such as a personal computer.

As shown in FIG. 1, this computer comprises a CPU 11, a north bridge 12, a main memory 13, a graphics controller 14, a video memory (VRAM) 14A, a liquid crystal display (LCD) 15, a south bridge 16, a BIOS-ROM 17, a hard disk drive (HDD) 18, an HD DVD drive 19, a sound controller 20, a speaker 21, an embedded controller/keyboard controller IC (EC/KBC) 22, a keyboard 23, a touch pad 24, a power supply circuit 25, a battery 26, and a network controller 27.

The CPU 11 is a processor which controls the operations of the respective parts in the computer. The CPU 11 executes an operating system (OS) 100 which is loaded from the HDD 18 into the main memory 13, and various application programs which operate under the control of the OS 100. The application programs include a video encoder application 200. The video encoder application 200 is software for encoding a moving picture, and operates as a software encoder which supports the H.264/AVC standard. The CPU 11 also executes a BIOS which is stored in the BIOS-ROM 17.

The north bridge 12 is a bridge device which connects a local bus of the CPU 11 and the south bridge 16. The north bridge 12 has a function of executing communication with the graphics controller 14 via a bus, and includes a memory controller which access-controls the main memory 13. The graphics controller 14 is a display controller for controlling the LCD 15 which is used as a display monitor of the computer. The graphics controller 14 generates a display signal, which is to be sent to the LCD 15, on the basis of image data that is written in the VRAM 14A.

The south bridge 16 is a controller which controls various devices on a PCI bus and an LPC bus. In addition, the south bridge 16 has a function of controlling the BIOS-ROM 17, HDD 18, HD DVD drive 19 and sound controller 20. The sound controller 20 is a sound source device which outputs an audio signal to the speaker 21.

The EC/KBC 22 is a 1-chip microcomputer in which an embedded controller for power management and a keyboard controller for controlling the keyboard 23 and touch pad 24 are integrated. The EC/KBC 22 cooperates with the power supply circuit 25 and generates power, which is to be supplied to the respective components, from power that is supplied from the battery 26 or from power that is supplied from an external AC power supply. The network controller 27 is a communication device which executes communication with an external network such as the Internet.

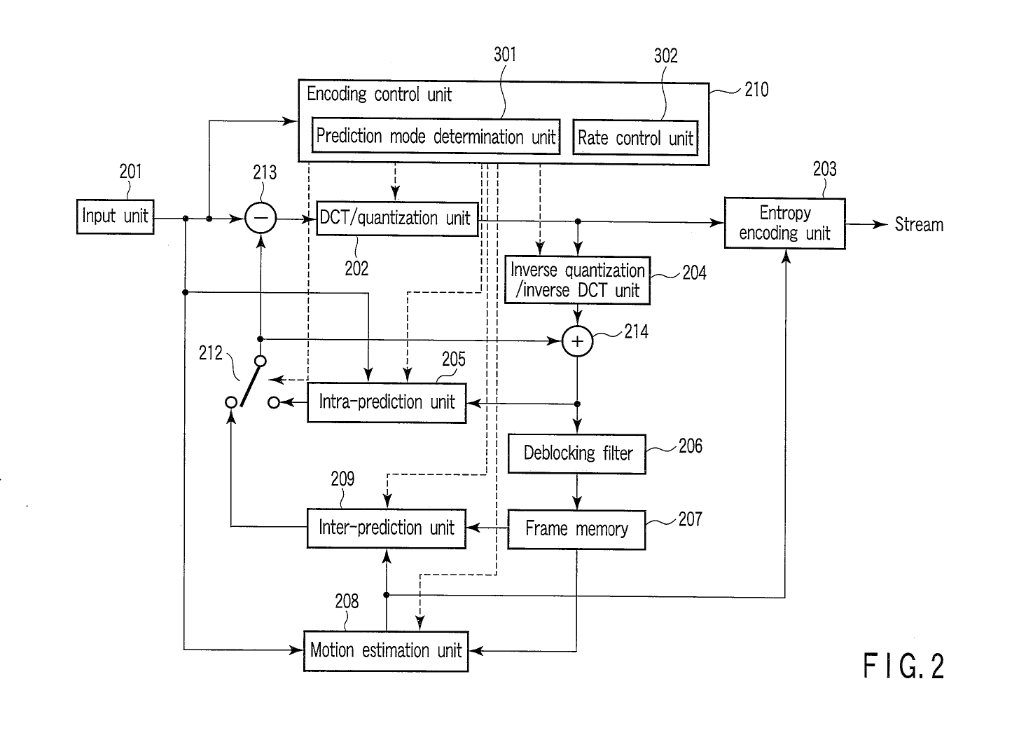

Next, referring to FIG. 2, a description is given of the functional structure of the software encoder which is realized by the video encoder application 200 which operates on the computer.

An encoding process by the video encoder application 200 corresponds to the H.264/AVC standard. As shown in FIG. 2, the video encoder application 200 includes, as its functional structure modules, an input unit 201, a DCT (Discrete Cosine Transform)/quantization unit 202, an entropy encoding unit 203, an inverse quantization/inverse DCT unit 204, an intra-prediction unit 205, a deblocking filter 206, a frame memory 207, a motion estimation unit 208, an inter-prediction unit 209, an encoding control unit 210, a switch 212, a subtraction unit 213, an addition unit 214, a prediction mode determination unit 301 and a rate control unit 302.

The video encoder application 200 divides each picture (frame or field) of a to-be-encoded moving picture signal, which is input from the input unit 201, into a plurality of macroblocks each having, e.g. 16×16 pixels, and encodes (compression-encodes) the picture while adaptively selecting a prediction mode in units of a macroblock.

The prediction mode determination unit 301 controls the DCT/quantization unit 202, inverse quantization/inverse DCT unit 204, intra-prediction unit 205, motion estimation unit 208 and inter-prediction unit 209, and determines, with respect to each of to-be-encoded macroblocks, one prediction mode, which is to be applied to the to-be-encoded macroblock, from a plurality of prediction modes which include prediction modes for intra-prediction coding and prediction modes for motion compensation inter-frame prediction coding (inter-prediction coding). Each macroblock is encoded (intra-prediction coding or inter-prediction coding) by the prediction mode which is determined by the prediction mode determination unit 301.

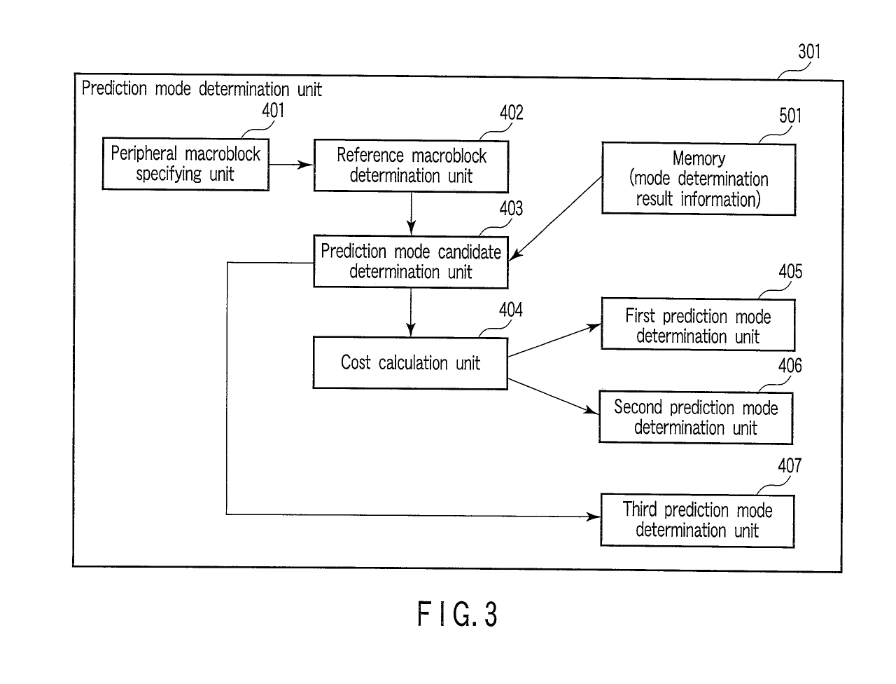

FIG. 3 shows functional blocks of the prediction mode determination unit 301.

As shown in FIG. 3, the prediction mode determination unit 301 includes a peripheral macroblock specifying unit 401, a reference macroblock determination unit 402, a prediction mode candidate determination unit 403, a cost calculation unit 404, a first prediction mode determination unit 405, a second prediction mode determination unit 406, and a third prediction mode determination unit 407.

The peripheral macroblock specifying unit 401 specifies a plurality of peripheral macroblocks which correspond to a to-be-encoded macroblock. The plural peripheral macroblocks are a plurality of macroblocks which are present in a to-be-encoded picture in which the to-be-encoded macroblock is present, and which neighbor the to-be-encoded macroblock in such a manner as to surround the to-be-encoded macroblock. As is shown in FIG. 5, peripheral macroblocks corresponding to, e.g. a macroblock 8 in a picture Pn are, for instance, eight neighboring macroblocks which are present around the macroblock 8, namely, neighboring macroblocks 1, 2, 3, 7, 9, 13, 14 and 15. Peripheral macroblocks corresponding to, e.g. a macroblock 1 are three neighboring macroblocks 2, 7 and 8 which surround the macroblock 1. Peripheral macroblocks corresponding to, e.g. a macroblock 2 are five neighboring macroblocks 1, 3, 7, 8 and 9 which surround the macroblock 2. Peripheral macroblocks corresponding to, e.g. a macroblock 30 are three neighboring macroblocks 23, 24 and 29 which surround the macroblock 30.

The reference macroblock determination unit 402 determines a plurality of reference macroblocks which correspond to the plural peripheral macroblocks surrounding the to-be-encoded macroblock. Each reference macroblock is a macroblock which is referred to in order to determine a prediction mode candidate which is to be applied to the to-be-encoded macroblock. An encoded macroblock, in other words, a macroblock for which prediction mode determination has already been executed by the prediction mode determination unit 301, is usable as a reference macroblock.

The reference macroblock determination unit 402 determines, with respect to each of macroblocks (“neighboring macroblocks”) belonging to the plural peripheral macroblocks specified by the peripheral macroblock specifying unit 401, whether the neighboring macroblock is an encoded macroblock or not. On the basis of the determination result, the reference macroblock determination unit 402 determines the reference macroblock corresponding to this neighboring macroblock.

Specifically, if the neighboring macroblock is an encoded macroblock, the reference macroblock determination unit 402 determines this neighboring macroblock itself as the reference macroblock corresponding to the neighboring macroblock.

If the neighboring macroblock is a non-encoded macroblock, the reference macroblock determination unit 402 determines an encoded macroblock, which is present in an immediately preceding encoded picture and is present at the same spatial position as the neighboring macroblock, as the reference macroblock corresponding to the neighboring macroblock. In other word, an encoded macroblock, which is included in a plurality of encoded macroblocks in an immediately preceding encoded picture and is present at the same spatial position as the spatial position of the neighboring macroblock in the to-be-encoded picture, is used as the reference macroblock corresponding to the neighboring macroblock.

For example, in FIG. 5, if macroblock 8 in the picture Pn is a to-be-encoded macroblock, since its neighboring macroblocks 1, 2, 3 and 7 are encoded macroblocks, these neighboring macroblocks 1, 2, 3 and 7 themselves are used as reference macroblocks corresponding to the neighboring macroblocks 1, 2, 3 and 7. On the other hand, since neighboring macroblocks 9, 13, 14 and 15 are non-encoded macroblocks, macroblocks 9, 13, 14 and 15 in an immediately preceding encoded picture Pn−1, which are present at the same spatial positions as the neighboring macroblocks 9, 13, 14 and 15, are used as reference macroblocks corresponding to the neighboring macroblocks 9, 13, 14 and 15. The picture Pn−1 is a picture which has been encoded immediately before the to-be-encoded picture Pn. In other words, the picture Pn−1 is a picture immediately prior to the present to-be-encoded picture Pn in the order of encoding.

As has been described above, in the case where a given macroblock included in peripheral macroblocks is a non-encoded macroblock, a macroblock in an immediately preceding picture, which is present at the same spatial position as this given macroblock, is used as a reference macroblock which corresponds to this given macroblock. Thereby, prediction mode determination results of a greater number of encoded macroblocks can be referred to.

The prediction mode candidate determination unit 403 refers to prediction mode determination results of the plural reference macroblocks which are determined by the reference macroblock determination unit 402, and determines a prediction mode candidate which is to be applied to the to-be-encoded macroblock.

Specifically, the prediction mode candidate determination unit 403 refers to the cost which is indicative of a code amount occurring in the encoding of each of the determined plural reference macroblocks, and which corresponds to each of the plural reference macroblocks, thereby selecting a reference macroblock with a lowest cost from the plural reference blocks. Then, the prediction mode candidate determination unit 403 determines a prediction mode, which is used in the encoding of the selected reference macroblock, as a prediction mode candidate which is to be applied to the to-be-encoded macroblock. Since mode determination result information (prediction mode, cost), which indicates a prediction mode determination result (prediction mode, cost) of each of encoded macroblocks, is stored in a memory 501, the prediction mode candidate determination unit 403 reads out the mode determination result information corresponding to each reference macroblock from the memory 501, thus being able to refer to the prediction mode and cost, which correspond to each reference macroblock.

The cost calculation unit 404 calculates the cost which is indicative of a code amount occurring in the case where the to-be-encoded macroblock is encoded by the prediction mode candidate that is determined by the prediction mode candidate determination unit 403. The cost corresponding to a certain macroblock is indicative of the code amount which occurs when this macroblock is encoded by a certain prediction mode. The cost of the to-be-encoded macroblock can be found, for example, by using a predetermined cost function. This cost function can be represented, for example, by a total value of a sum of absolute difference (SAD) of a prediction error between a predicted image and an original image and an encoding coefficient data amount (header data amount) including a motion vector. In addition, the cost indicative of the occurring code amount may be represented by only the sum of absolute difference (SAD). Furthermore, the code amount occurring in the case where the to-be-encoded macroblock is encoded by a certain prediction mode can be calculated by other various cost functions as the cost for encoding the to-be-encoded macroblock. Needless to say, a process of actually encoding a to-be-encoded macroblock by a prediction mode candidate may be carried out as a trial encoding process, and the cost in the case of encoding the to-be-encoded macroblock by the prediction mode candidate may be calculated on the basis of the result of the trial encoding process.

The first prediction mode determination unit 405 determines whether the cost that is calculated by the cost calculation unit 404 is equal to or less than a predetermined evaluation cost threshold. If a prediction mode candidate evaluation condition that the cost that is calculated by the cost calculation unit 404 is equal to or less than the evaluation cost threshold is satisfied, the first prediction mode determination unit 405 determines the prediction mode candidate as a prediction mode which is to be applied to the to-be-encoded macroblock. In this case, the process of calculating the cost relating to prediction modes, other than the prediction mode candidate, is skipped. The cost of the reference macroblock, which is selected by the prediction mode candidate determination unit 403, is used as the evaluation cost threshold.

If the cost that is calculated by the cost calculation unit 404 is greater than the evaluation cost threshold, the second prediction mode determination unit 406 determines a prediction mode which is to be applied to the to-be-encoded macroblock. In this case, the second prediction mode determination unit 406 calculates costs indicative of the code amounts which occur in cases where the to-be-encoded macroblock is encoded by all prediction modes other than the prediction mode candidate. The second prediction mode determination unit 406 determines a prediction mode having a lowest calculated cost of all usable prediction modes as a prediction mode that is to be applied to the to-be-encoded macroblock.

As has been described above, in the present embodiment, to begin with, the prediction mode candidate, which is to be applied to the to-be-encoded macroblock, is determined by using the prediction mode determination results (or encoding results) of the reference macroblocks corresponding to the to-be-encoded macroblock. In this case, the reference macroblock having the lowest cost of the plural reference macroblocks is selected, and the prediction mode, which was applied to the selected reference macroblock, is determined as the prediction mode candidate (initial prediction mode) of the to-be-encoded macroblock. The spatial correlation between each reference macroblock and the to-be-encoded macroblock is relatively strong. Thus, by referring to the prediction mode determination result corresponding to each of the plural reference macroblocks, a more proper prediction mode can be selected from the plural prediction modes, which include prediction modes for intra-prediction coding and prediction modes for inter-prediction coding, as a prediction mode candidate which is to be applied to the to-be-encoded macroblock.

If the cost in the case of encoding the to-be-encoded macroblock by the prediction mode candidate is equal to or less than the evaluation cost threshold, the prediction mode determination process for the to-be-encoded macroblock is finished at this time point, and the execution of the process of evaluating the prediction modes, other than the prediction mode candidate, is skipped. Therefore, in the present embodiment, the prediction mode can be determined by only a single cost calculation operation at the minimum, and the processing amount necessary for the prediction mode determination process can be reduced.

In the present embodiment, if the cost in the case of encoding the to-be-encoded macroblock by the prediction mode candidate is greater than the cost of the selected reference macroblock, the costs corresponding to the prediction modes other than the prediction mode candidate are evaluated, and the prediction mode, which is to be applied to the to-be-encoded macroblock, is determined on the basis of the evaluation results. Accordingly, degradation in image quality can be prevented, compared to the case of using a method of restricting the kinds of usable prediction modes to some specific kinds of prediction modes in order to reduce the processing amount of the prediction mode determination process.

Furthermore, in the present embodiment, not only encoded macroblocks which are present in the to-be-encoded picture, but also macroblocks which are present in the immediately preceding picture are used as reference macroblocks. Thereby, prediction mode determination results of a greater number of encoded macroblocks can be referred to, compared to the structure wherein the prediction mode of the to-be-encoded macroblock is determined on the basis of the prediction mode determination result of only the encoded macroblocks which are present in the same picture as the to-be-encoded macroblock. Therefore, a more proper prediction mode for the to-be-encoded macroblock can be determined as the prediction mode candidate of the to-be-encoded macroblock.

The prediction mode determination process, which determines the prediction mode of the to-be-encoded macroblock by making use of the prediction mode determination result of each of the reference macroblocks, may be executed on condition that the cost of the reference macroblock that is selected by the prediction mode determination unit 403, that is, the lowest one of the costs of the reference macroblocks, is equal to or less than a reference value. In this case, if the cost of the reference macroblock that is selected by the prediction mode determination unit 403 is greater than the reference value, the third prediction mode determination unit 407 executes an ordinary prediction mode determination process of evaluating the cost of each of all usable prediction modes.

Specifically, the third prediction mode determination unit 407 determines whether the cost of the reference macroblock that is selected by the prediction mode determination unit 403, that is, the lowest one of the costs of the reference macroblocks, is greater than the reference value. In the case where the cost of the reference macroblock is greater than the reference value, the third prediction mode determination unit 407 calculates the encoding costs in cases where the to-be-encoded macroblock is encoded by all the above-described prediction modes, and determines the prediction mode, which has a lowest cost of all the plural prediction modes, as the prediction mode that is to be applied to the to-be-encoded macroblock.

The above-described ordinary prediction mode determination process may be executed not only in the case where the condition that the cost of the selected reference macroblock is greater than the reference value, but also in the case where no encoded macroblock is included in the plural peripheral macroblocks which are specified by the peripheral macroblock specifying unit 401. In this case, for example, if macroblock 1 in the picture Pn in FIG. 5 is the to-be-encoded macroblock, since none of the peripheral macroblocks 2, 7 and 8 corresponding to the macroblock 1 is encoded, the above-described ordinary prediction mode determination process, which is executed by the third prediction mode determination unit 407, is applied to the prediction mode determination of the to-be-encoded macroblock 1.

In the meantime, in the high profile of the H.264/AVC standard, in the case where the block size (the size of the motion compensation block) of the prediction mode is 8×8 pixels or more in the inter-prediction coding, a proper one of a DCT with a block size of 4×4 pixels and a DCT with a block size of 8×8 pixels can be selected. In the inter-prediction coding, seven prediction modes, which correspond to seven motion compensation block sizes (16×16 pixels, 16×8 pixels, 8×16 pixels, 8×8 pixels, 8×4 pixels, 4×8 pixels, and 4×4 pixels), can selectively be used. Thus, if there are an M-number of kinds of prediction modes (motion compensation block sizes) which are usable in the inter-prediction coding, and if DCTs corresponding to an N-number of kinds of block sizes are usable, an M×N number of kinds of prediction modes are substantially present with respect to the inter-prediction coding alone. In such a situation, if such a structure is adopted that an optimal prediction mode is selected by performing evaluation with respect to all prediction modes (combinations of motion compensation block sizes and DCT block sizes) without making any device, the processing amount that is required in the prediction mode determination process of the inter-prediction becomes enormous. Therefore, the prediction mode determination process of the present embodiment is very effective.

Besides, in the intra-prediction coding, there are nine prediction modes (prediction directions) with respect to each of the prediction block shape of 4×4 pixels and the prediction block shape of 8×8 pixels, and there are four prediction modes (prediction directions) with respect to the prediction block shape of 16×16 pixels.

In the case where the encoding mode that is applied to the to-be-encoded picture is a P picture (Predictive-picture) or a B picture (Bi-Predictive Prediction-picture), not only macroblocks which are subjected to inter-prediction coding, but also macro-blocks which are subjected to intra-prediction coding may be included. Thus, the number of kinds of usable prediction modes becomes very large.

In the present embodiment, the prediction mode can be determined by only a single prediction determination process at the minimum. Therefore, no matter whether the to-be-encoded picture is a P picture or a B picture, the processing amount that is necessary for the prediction mode determination can remarkably be reduced.

In the software encoder with the functional structure shown in FIG. 2, the intra-prediction unit 205 selectively executes, under the control of the prediction mode determination process unit 301, prediction processes corresponding to the plural prediction modes for the intra-prediction coding. At the time of the intra-prediction coding mode, the prediction mode determination process unit 301 selects the intra-prediction unit 205 by the switch 212. In accordance with the prediction mode for intra-prediction which is determined by the prediction mode determination process unit 301, the intra-prediction unit 205 generates a prediction signal, which corresponds to each block in the to-be-encoded macroblock, from some encoded blocks in the to-be-encoded picture. The subtraction unit 213 produces a prediction error signal which is obtained by subtracting the prediction signal from the to-be-encoded picture. This prediction error signal is orthogonal-transformed and quantized by the DCT/quantization unit 202. The quantized orthogonal-transformation coefficient, together with intra-prediction mode information indicative of the intra-prediction mode, is entropy-encoded by the entropy encoding unit 203.

On the other hand, at the time of the inter-prediction coding mode, the motion estimation unit 208 first estimates the motion from the already encoded picture that is stored in the frame memory 207, and then the inter-prediction unit 209 generates, in units of a predetermined block shape, a motion compensation inter-frame prediction signal corresponding to the to-be-encoded macroblock, in accordance with the prediction mode that is determined by the prediction mode determination process unit 301. Specifically, the motion compensation inter-frame prediction signal is generated in units of a motion compensation block size corresponding to the prediction mode that is determined by the prediction mode determination process unit 301. A prediction error signal, which is produced by subtracting the motion compensation inter-frame prediction signal from the to-be-encoded picture, is orthogonal-transformed (DCT) and quantized by the DCT/quantization unit 202. The quantized orthogonal-transformation coefficients, which are obtained by the DCT/quantization unit 202, are sent to the entropy encoding unit 203. The entropy encoding unit 203 entropy-encodes the quantized orthogonal-transformation coefficients and the inter-prediction mode information (prediction mode, motion vector information, etc.).

The inverse quantization/inverse DCT unit 204 executes inverse quantization and inverse orthogonal transformation of the quantization coefficient of the picture, which has been orthogonal-transformed and quantized. The deblocking filter 206 executes a deblocking filter process for reducing block noise.

The rate control unit 302 executes, e.g. setting of quantization parameters in order to adjust the rate (generated code amount) of an encoded stream which is output from the entropy encoding unit 203.

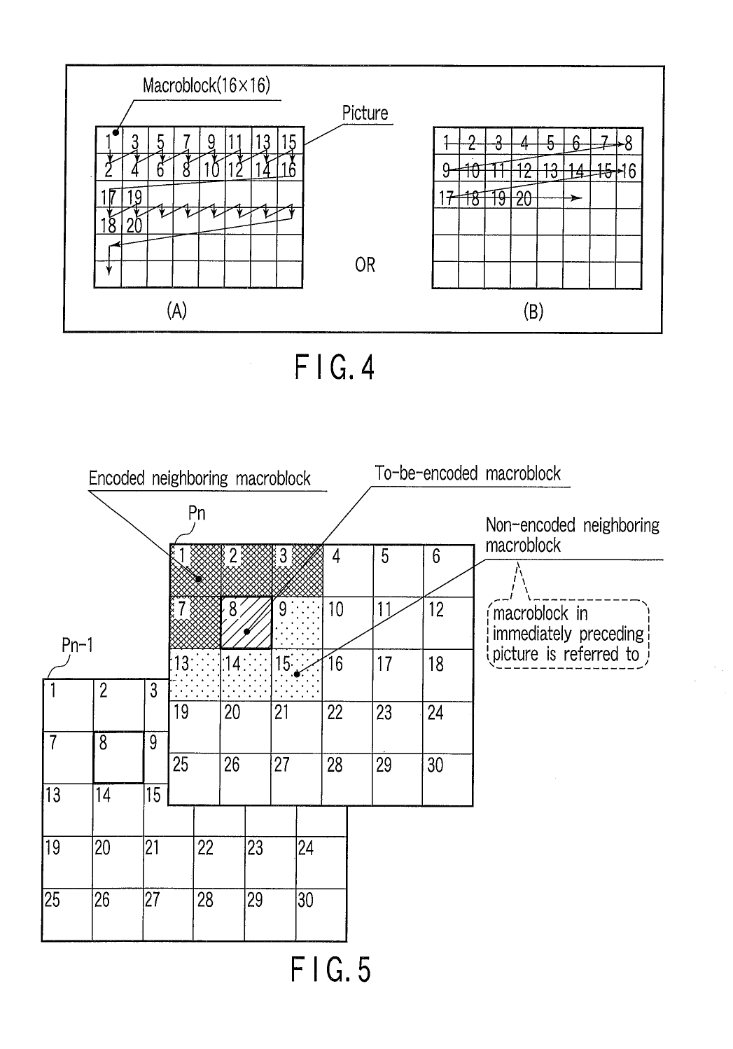

FIG. 4 shows orders of encoding of macroblocks in the picture.

The picture is divided into a plurality of macroblocks, and the macroblocks are encoded in an order shown in part (A) of FIG. 4 or in an order (raster scan) shown in part (B) of FIG. 4. When each macroblock is encoded, the prediction mode determination process is first executed.

FIG. 5 shows a relationship between a to-be-encoded macroblock and reference macroblocks in the prediction mode determination process in a case where encoding is executed in the order (raster scan) shown in part (B) of FIG. 4.

The picture Pn is the present to-be-encoded picture. For example, in a case where macroblock 8 in the picture Pn is the to-be-encoded macroblock, macroblocks 1, 2, 3, 7, 9, 13, 14 and 15 in the picture Pn, which surround the macroblock 8 and neighbor the macroblock 8, are specified as peripheral macroblocks corresponding to the to-be-encoded macroblock 8. Since the macroblocks 1, 2, 3 and 7 in the picture Pn are encoded, these encoded macroblocks 1, 2, 3 and 7 are determined as reference macroblocks which are to be used in order to determine a prediction mode candidate of the to-be-encoded macroblock 8. Since the macroblocks 9, 13, 14 and 15 in the picture Pn are not encoded, macroblocks 9, 13, 14 and 15 in an immediately preceding picture Pn−1, which are present at the same spatial positions as the macroblocks 9, 13, 14 and 15 in the picture Pn, are determined as reference macroblocks.

A reference macroblock with a lowest cost is selected from the reference macroblocks 1, 2, 3 and 7 in the picture Pn and the reference macroblocks 9, 13, 14 and 15 in the picture Pn−1, and the same prediction mode as the prediction mode, which is used in the encoding of the selected reference macroblock, is determined as a prediction mode candidate (an initial prediction mode of the to-be-encoded macroblock 8) which is to be applied to the to-be-encoded macroblock 8. In addition, the cost in the case where the to-be-encoded macroblock 8 is encoded by the prediction mode candidate is calculated. If the calculated cost is equal to or less than the cost of the selected reference macroblock, the prediction mode candidate becomes the prediction mode of the to-be-encoded macroblock 8, and evaluation on other prediction modes is skipped.

If macroblock 30 in the picture Pn is the to-be-encoded macroblock, macroblocks 23, 24 and 29 in the picture Pn, which surround the macroblock 30 and neighbor the macroblock 30, are specified as peripheral macroblocks corresponding to the to-be-encoded macroblock 30. Since all the macroblocks 23, 24 and 29 in the picture Pn are encoded, these encoded macroblocks 23, 24 and 29 in the picture Pn are determined as reference macroblocks which are to be used in order to determine a prediction mode candidate of the to-be-encoded macroblock 30.

A macroblock with a lowest cost is selected from the macroblocks 23, 24 and 29 in the picture Pn, and the same prediction mode as the prediction mode, which is used in the encoding of the selected macroblock, is determined as a prediction mode candidate which is to be applied to the to-be-encoded macroblock 30.

If macroblock 1 in the picture Pn is the to-be-encoded macroblock, macroblocks 2, 7 and 8 in the picture Pn, which surround the macroblock 1 and neighbor the macroblock 1, are specified as peripheral macroblocks corresponding to the to-be-encoded macroblock 1. Since all the macroblocks 2, 7 and 8 in the picture Pn are not encoded, macroblocks 2, 7 and 8 in the immediately preceding picture Pn−1, which are present at the same spatial positions as the macroblocks 2, 7 and 8 in the picture Pn, are determined as reference macroblocks.

A macroblock with a lowest cost is selected from the macroblocks 2, 7 and 8 in the picture Pn−1, and the same prediction mode as the prediction mode, which is used in the encoding of the selected macroblock, is determined as a prediction mode candidate which is to be applied to the to-be-encoded macroblock 1.

Since the peripheral macroblocks of the to-be-encoded macroblock 1 include no encoded macroblock, as described above, the prediction mode that is to be applied to the to-be-encoded macroblock 1 may be determined by the ordinary prediction mode determination process.

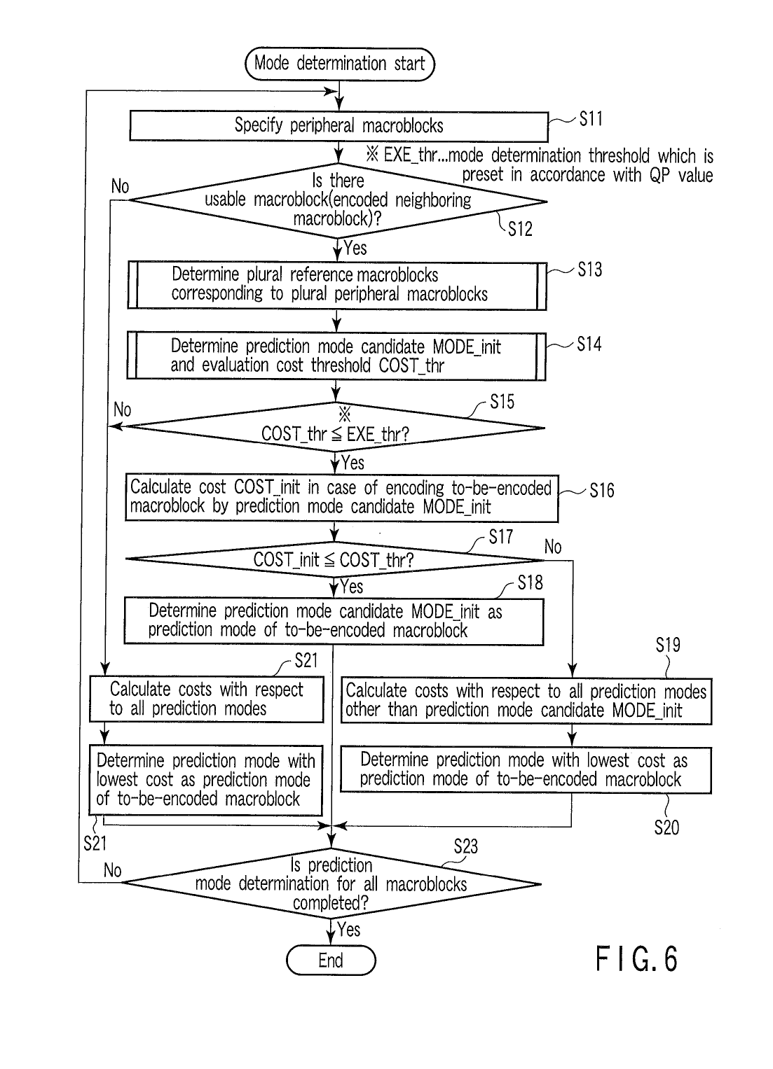

Next, referring to FIG. 6, a description is given of an example of the specific procedure of the prediction mode determination process of the present embodiment, which is executed for a to-be-encoded macroblock. In this example, it is assumed that if there is no encoded macroblock in peripheral macroblocks corresponding to the to-be-encoded macroblock, the prediction mode that is to be applied to the to-be-encoded macroblock is determined by using an ordinary prediction mode determination process.

To start with, the prediction mode determination unit 301 specifies peripheral blocks corresponding to the to-be-encoded macroblock (block S11). The peripheral macroblocks, as described above, are a plurality of macroblocks which are present in a to-be-encoded picture in which the to-be-encoded macroblock is present, and which neighbor the to-be-encoded macroblock in such a manner as to surround the to-be-encoded macroblock.

Then, the prediction mode determination unit 301 determines whether a macroblock which is usable in determining a prediction mode candidate of the to-be-encoded macroblock, that is, an encoded macroblock, is included in the specified macroblocks (block S12).

If a usable macroblock is not included in the peripheral macroblocks (NO in block S12), the prediction mode determination unit 301 calculates costs in cases where the to-be-encoded macroblock is encoded by all usable prediction modes, thereby to evaluate all usable prediction modes (block S21). The prediction mode determination unit 301 determines a prediction mode with a lowest calculated cost of all the usable prediction modes as a prediction mode which is to be applied to the to-be-encoded macroblock (block S22).

On the other hand, if a usable macroblock is included in the peripheral macroblocks (YES in block S12), the prediction mode determination unit 301 determines a reference macroblock corresponding to each of the peripheral macroblocks (block S13). In block S13, with respect to each of the peripheral macroblocks, the prediction mode determination unit 301 determines whether the peripheral macroblock is encoded or not, and determines, on the basis of the determination result, a reference macroblock corresponding to each peripheral macroblock.

Subsequently, on the basis of a prediction mode determination result of each reference macroblock (or on the basis of a result of actual encoding of each reference macroblock), the prediction mode determination unit 301 determines a prediction mode candidate MODE_init which is to be applied to the to-be-encoded macroblock, and the above-described evaluation cost threshold COST_thr (block S14). In block S14, a reference macroblock with a lowest cost is selected from the reference macroblocks, and the prediction mode, which has been used in the encoding of the selected reference macroblock, is determined as the prediction mode candidate MODE_init. In addition, the cost corresponding to the selected reference macroblock is determined as the evaluation cost threshold COST_thr.

Next, the prediction mode determination unit 301 determines whether the evaluation cost threshold COST_thr is equal to or less than a predetermined reference value (=mode determination threshold EXE_thr) (block S15). The value of the mode determination threshold EXE_thr is predetermined, for example, in accordance with a quantization parameter QP for adjusting an encoding bit rate.

If the evaluation cost threshold COST_thr, which is the cost of the selected reference macroblock, is greater than the mode determination threshold EXE_thr (NO in block S15), the prediction mode determination unit 301 calculates costs in cases where the to-be-encoded macroblock is encoded by all usable prediction modes, thereby to evaluate all usable prediction modes (block S21). Then, the prediction mode determination unit 301 determines a prediction mode with a lowest calculated cost of all the usable prediction modes as a prediction mode which is to be applied to the to-be-encoded macroblock (block S22).

On the other hand, if the evaluation cost threshold COST_thr is equal to or less than the mode determination threshold EXE_thr (YES in block S15), the prediction mode determination unit 301 calculates a cost COST_init indicative of a code amount which occurs in a case where the to-be-encoded macroblock is encoded by the prediction mode candidate MODE_init (block S16). In block S16, for example, the to-be-encoded macroblock may actually be encoded by the prediction mode candidate MODE_init, and the cost COST_init may be obtained on the basis of the result of the encoding. In this case, for example, almost all processes, except entropy encoding, are executed in the process of encoding the to-be-encoded macroblock by the prediction mode candidate MODE_init, and the cost COST_init is obtained on the basis of the processing result.

Subsequently, the prediction mode determination unit 301 compares the cost COST_init and the evaluation cost threshold COST_thr, and determines whether the cost COST_init is equal to or less than the evaluation cost threshold COST_thr (block S17).

If the cost COST_init is equal to or less than the evaluation cost threshold COST_thr (YES in block S17), the prediction mode determination unit 301 determines the prediction mode candidate MODE_init as the prediction mode that is to be applied to the to-be-encoded macroblock (block S18).

On the other hand, if the cost COST_init is greater than the evaluation cost threshold COST_thr (NO in block S17), the prediction mode determination unit 301 calculates costs in cases where the to-be-encoded macroblock is encoded by all usable prediction modes other than the prediction mode candidate MODE_init (block S19). Then, the prediction mode determination unit 301 determines a prediction mode with a lowest cost of all the usable prediction modes as the prediction mode that is to be applied to the to-be-encoded macroblock (block S20).

The process of the above blocks S11 to S22 is repeatedly executed by altering the to-be-encoded macroblock, until the prediction mode determination process for all macroblocks is completed (block S23).

As has been described above, in the prediction mode determination process, almost all encoding processes, excluding the entropy encoding, may be executed for the calculation of the cost. In this case, at the time point when the prediction mode to be applied is determined, the other process, such as the entropy encoding, can be executed, and therefore the encoding can be performed with high efficiency. Needless to say, the entropy encoding may be executed in the prediction mode determination process, and this enables the cost calculation and evaluation with higher prediction precision and more exactly than in the case of skipping the entropy encoding. However, if the entropy encoding is executed, the amount of computation for the cost calculation increases accordingly.

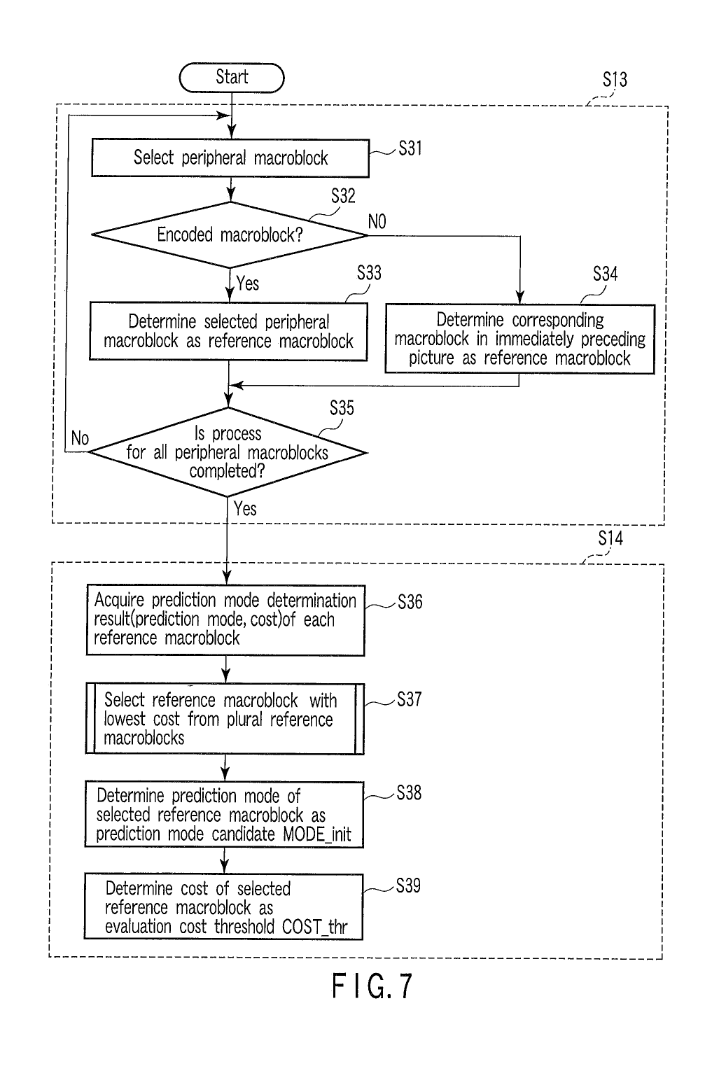

Next, referring to a flow chart of FIG. 7, an example of the process procedures, which are executed in blocks S13 and S14 in FIG. 6, is described.

After the peripheral macroblocks corresponding to the to-be-encoded macroblock in the to-be-encoded picture are specified, the prediction mode determination unit 301 executes the following process with respect to each of the peripheral macroblocks.

Specifically, the prediction mode determination unit 301 selects one to-be-processed peripheral macroblock from the peripheral macroblocks (block S31), and determines whether the selected peripheral macroblock is an encoded macroblock, that is, an macroblock which has already been subjected to the prediction mode determination (block S32).

If the selected peripheral macroblock is an encoded macroblock (YES in block S32), the prediction mode determination unit 301 determines this selected peripheral macroblock itself as a reference macroblock corresponding to the selected peripheral macroblock (block S33).

On the other hand, if the selected peripheral macroblock is not an encoded macroblock (NO in block S32), the prediction mode determination unit 301 determines a macroblock in a picture, which immediately precedes the to-be-encoded picture and is present at the same spatial position as the selected peripheral macroblock, as a reference macroblock corresponding to the selected peripheral macroblock (block S34).

The process of blocks S31 to S34 is repeatedly executed until the process for all peripheral macroblocks of the to-be-encoded picture is completed (block S35).

After reference macroblocks corresponding to all peripheral macroblocks of the to-be-encoded picture are determined (YES in block S35), the prediction mode determination unit 301 acquires from, e.g. the memory 51 the prediction mode determination result (prediction mode, cost) of each reference macroblock (block S36). Then, the prediction mode determination unit 301 determines a reference macroblock with a lowest cost of the reference macroblocks corresponding to all peripheral macroblocks (block S37). Then, the prediction mode determination unit 301 determines the prediction mode, which has been used in the encoding of the selected reference macroblock, as the prediction mode candidate MODE_init of the to-be-encoded macroblock (block S38), and also determines the cost, which is indicative of the code amount occurring in the encoding of the selected reference macroblock, as the evaluation cost threshold COST_thr (block S39).

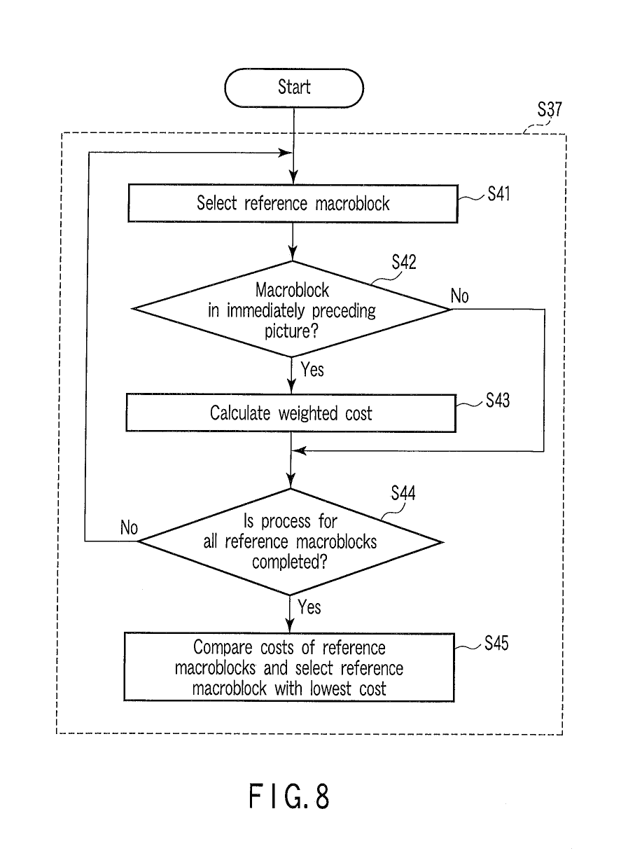

Next, referring to a flow chart of FIG. 8, a description is given of an example of the process procedure of selecting the reference macroblock with the lowest cost, which is executed in block S37 in FIG. 7.

As has been described above, some reference macroblocks include reference macroblocks which are present in the same to-be-encoded picture as the to-be-encoded macroblock, and reference macroblocks which are present in a picture immediately preceding the to-be-encoded picture. In the process of selecting the reference macroblock with the lowest cost from the reference macroblocks, it may be possible to preferentially select the reference macroblocks which are present in the to-be-encoded picture, rather than the reference macroblocks which are present in the immediately preceding picture. In general, in many cases, the correlation between the to-be-encoded picture and the reference macroblock which is present in the to-be-encoded picture is stronger than the correlation between the to-be-encoded picture and the reference macroblock which is present in the immediately preceding picture.

According to whether each reference macro-block belongs to the to-be-encoded picture or the immediately preceding picture, the prediction mode determination unit 301 weights the cost of each reference macroblock so that the reference macroblock that is present in the to-be-encoded picture may be preferentially selected rather than the reference macroblock belonging to the immediately preceding picture, and the prediction mode determination unit 301 selects the reference macroblock with a lowest weighted cost of the plural reference macroblocks.

In the process of weighting the cost of each reference macroblock, it is not always necessary to multiply, by a weighting coefficient, both of each reference macroblock that is present in the to-be-encoded picture and each reference macroblock belonging to the immediately preceding picture. For example, it is possible to multiply, by a weighting coefficient greater than 1, only the cost of each reference macroblock belonging to the immediately preceding picture.

Next, by exemplifying the case of multiplying, by a weighting coefficient greater than 1, only the cost of each reference macroblock belonging to the immediately preceding picture, a description is given of the procedure of the process of selecting the reference macroblock with the lowest cost by using the weighted costs.

After the plural reference macroblocks, which correspond to the plural peripheral macroblocks surrounding the to-be-encoded macroblock, are determined, the prediction mode determination unit 301 executes the following process.

To start with, the prediction mode determination unit 301 selects a to-be-processed reference macroblock from the plural reference macroblocks (block S41), and determines whether the selected to-be-processed reference macroblock is a macroblock belonging to the immediately preceding picture (block S42).

If the to-be-processed reference macroblock is a macroblock belonging to the immediately preceding picture (YES in block S42), the prediction mode determination unit 301 multiplies the cost of the to-be-processed reference macroblock by a weighting coefficient greater than 1, thereby calculating the weighted cost of the to-be-processed reference macroblock (block S43).

The process of blocks S41 to S43 is repeatedly executed by altering the to-be-processed reference macroblock, until the process for all reference macroblocks corresponding to the to-be-encoded picture is completed.

If the process for all reference macroblocks is completed (YES in block S44), the prediction mode determination unit 301 compares the costs (including weighted costs) of all reference macroblocks, and selects the reference macroblock with the lowest cost of all the reference macroblocks (block S45).

As has been described above, according to the present embodiment, the prediction mode can be efficiently determined with a small processing amount while suppressing degradation in image quality. Therefore, the process of encoding a moving picture signal can be executed at high speed.

The entire encoding process including the prediction mode determination process can be executed by the video encoder application 200. Thus, by installing this application program in an ordinary computer via a computer-readable memory medium, the same advantageous effects as in the present embodiment can easily be realized.

The various modules of the video encoder application 200, which have been described with reference to FIG. 2, can also be realized by dedicated hardware circuits. In addition, the video encoder application 200 may be realized as firmware which operates on a processor other than the CPU 11, such as a DSP.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A moving picture encoding apparatus which divides each of pictures of a to-be-encoded moving picture signal into a plurality of macroblocks, selects, with respect to each of the macroblocks, one prediction mode from a plurality of prediction modes including prediction modes for inter-frame prediction coding and prediction modes for intra-frame prediction coding, and encodes the macroblock by the selected prediction mode, comprising:
a peripheral macroblock specifying module configured to specify a plurality of peripheral macroblocks which correspond to a to-be-encoded macroblock, the plurality of peripheral macroblocks being a plurality of macroblocks which are present in a to-be-encoded picture in which the to-be-encoded macroblock is present, and which neighbor the to-be-encoded macroblock in such a manner as to surround the to-be-encoded macroblock;
a reference macroblock determination module configured to determine, with respect to each of the macroblocks in the specified plural macroblocks, whether the macroblock is an encoded macroblock or not, to determine, if the macroblock is the encoded macroblock, the macroblock as a reference macroblock which is to be used in order to determine a prediction mode candidate of the to-be-encoded macroblock, and to determine, if the macroblock is a non-encoded macroblock, an encoded macroblock, which is present in an encoded picture immediately preceding the to-be-encoded picture and which is present at the same spatial position as the macroblock, as the reference macroblock, thereby determining a plurality of reference macroblocks which correspond to the plural peripheral macroblocks;
a prediction mode candidate determination module configured to refer to a cost which indicate a code amount occurring in encoding of each of the determined plural reference macroblocks, thereby selecting a reference macroblock with a lowest cost of the plural reference blocks, and determining a prediction mode, which is used in the encoding of the selected reference macroblock, as a prediction mode candidate which is to be applied to the to-be-encoded macroblock;
a cost calculation module configured to calculate a cost which is indicative of a code amount occurring in a case where the to-be-encoded macroblock is encoded by the determined prediction mode candidate;
a first prediction mode determination module configured to determine, if the calculated cost is equal to or less than the cost of the selected reference macroblock, the determined prediction mode candidate as a prediction mode which is to be applied to the to-be-encoded macroblock; and
a second prediction mode determination module configured to calculate, if the calculated encoding cost is greater than the encoding cost of the selected macroblock, costs indicative of code amounts which occur in cases where the to-be-encoded macroblock is encoded by prediction modes other than the prediction mode candidate, and to determine a prediction mode with a lowest cost of the prediction modes as a prediction mode which is to be applied to the to-be-encoded macroblock.

2. The moving picture encoding apparatus according to claim 1, further comprising:
a determination module configured to determine whether the cost of the selected reference macroblock is greater than a reference value; and
a third prediction mode determination module configured to calculate, if the cost of the selected reference macroblock is greater than the reference value, costs indicative of code amounts which occur in cases where the to-be-encoded macroblock is encoded by the plural prediction modes, and to determine a prediction mode with a lowest cost of the plural prediction modes as a prediction mode which is to be applied to the to-be-encoded macroblock.

3. The moving picture encoding apparatus according to claim 1, wherein in a case where the plurality of reference macroblocks include reference macroblocks which are present in the to-be-encoded picture and reference macroblocks which are present in the immediately preceding encoded picture, the prediction mode candidate determination module weights the cost of each of the plural reference macroblocks in such a manner that the reference macroblock which is present in the to-be-encoded picture is preferentially selected rather than the reference macroblock belonging to the immediately preceding picture, and selects a reference macroblock with a lowest weighted cost of the plural reference macroblocks.

4. The moving picture encoding apparatus according to claim 3, wherein in order to weight the cost of each of the plural reference macroblocks, the prediction mode candidate determination module multiplies, by a weighting coefficient greater than 1, the cost of the reference macroblock belonging to the immediately preceding picture.

5. The moving picture encoding apparatus according to claim 1, wherein the third prediction mode determination module is configured to calculate, in a case one of a condition that the cost of the selected reference macroblock is greater than the reference value and a condition that the specified plural peripheral macroblocks include no encoded macroblock is satisfied, the costs indicative of the code amounts which occur in cases where the to-be-encoded macroblock is encoded by the plural prediction modes, and to determine a prediction mode with a lowest cost of the plural prediction modes as a prediction mode which is to be applied to the to-be-encoded macroblock.

6. A moving picture encoding method which divides each of pictures of a to-be-encoded moving picture signal into a plurality of macroblocks, selects, with respect to each of the macroblocks, one prediction mode from a plurality of prediction modes including prediction modes for inter-frame prediction coding and prediction modes for intra-frame prediction coding, and encodes the macroblock by the selected prediction mode, the method comprising:
specifying a plurality of peripheral macroblocks which correspond to a to-be-encoded macroblock, the plurality of peripheral macroblocks being a plurality of macroblocks which are present in a to-be-encoded picture in which the to-be-encoded macroblock is present, and which neighbor the to-be-encoded macroblock in such a manner as to surround the to-be-encoded macroblock;
determining, with respect to each of the macroblocks in the specified plural macroblocks, whether the macroblock is an encoded macroblock or not, determining, if the macroblock is the encoded macro-block, the macroblock as a reference macroblock which is to be used in order to determine a prediction mode candidate of the to-be-encoded macroblock, and determining, if the macroblock is a non-encoded macroblock, an encoded macroblock, which is present in an encoded picture immediately preceding the to-be-encoded picture and which is present at the same spatial position as the macroblock, as the reference macroblock, thereby determining a plurality of reference macroblocks which correspond to the plural peripheral macroblocks;
referring to a cost which indicate a code amount occurring in encoding of each of the determined plural reference macroblocks, thereby selecting a reference macroblock with a lowest cost of the plural reference blocks, and determining a prediction mode, which is used in the encoding of the selected reference macroblock, as a prediction mode candidate which is to be applied to the to-be-encoded macroblock;
calculating a cost which is indicative of a code amount occurring in a case where the to-be-encoded macroblock is encoded by the determined prediction mode candidate;
determining, if the calculated cost is equal to or less than the cost of the selected reference macroblock, the determined prediction mode candidate as a prediction mode which is to be applied to the to-be-encoded macroblock; and
calculating, if the calculated encoding cost is greater than the encoding cost of the selected macroblock, costs indicative of code amounts which occur in cases where the to-be-encoded macroblock is encoded by prediction modes other than the prediction mode candidate, and determining a prediction mode with a lowest cost of the prediction modes as a prediction mode which is to be applied to the to-be-encoded macroblock.

7. The moving picture encoding method according to claim 6, further comprising:
determining whether the cost of the selected reference macroblock is greater than a reference value; and
calculating, if the cost of the selected reference macroblock is greater than the reference value, costs indicative of code amounts which occur in cases where the to-be-encoded macroblock is encoded by the plural prediction modes, and determining a prediction mode with a lowest cost of the plural prediction modes as a prediction mode which is to be applied to the to-be-encoded macroblock.

8. The moving picture encoding method according to claim 6, wherein in a case where the plurality of reference macroblocks include reference macroblocks which are present in the to-be-encoded picture and reference macroblocks which are present in the immediately preceding encoded picture, said determining the prediction mode candidate includes weighting the cost of each of the plural reference macroblocks in such a manner that the reference macroblock which is present in the to-be-encoded picture is preferentially selected rather than the reference macroblock belonging to the immediately preceding picture, and selecting a reference macroblock with a lowest weighted cost of the plural reference macroblocks.

9. The moving picture encoding method according to claim 6, further comprising:
determining whether an encoded macroblock is included in the specified plural peripheral macroblocks; and
calculating costs indicative of code amounts which occur in cases where the to-be-encoded macroblock is encoded by the plural prediction modes, and determining a prediction mode with a lowest cost of the plural prediction modes as a prediction mode which is to be applied to the to-be-encoded macroblock.

10. A program which causes a computer to execute a process of dividing each of pictures of a to-be-encoded moving picture signal into a plurality of macroblocks, selecting, with respect to each of the macroblocks, one prediction mode from a plurality of prediction modes including prediction modes for inter-frame prediction coding and prediction modes for intra-frame prediction coding, and encoding the macroblock by the selected prediction mode, the program comprising:
causing the computer to specify a plurality of peripheral macroblocks which correspond to a to-be-encoded macroblock, the plurality of peripheral macroblocks being a plurality of macroblocks which are present in a to-be-encoded picture in which the to-be-encoded macroblock is present, and which neighbor the to-be-encoded macroblock in such a manner as to surround the to-be-encoded macroblock;
causing the computer to determine, with respect to each of the macroblocks in the specified plural macroblocks, whether the macroblock is an encoded macroblock or not, to determine, if the macroblock is the encoded macroblock, the macroblock as a reference macroblock which is to be used in order to determine a prediction mode candidate of the to-be-encoded macroblock, and to determine, if the macroblock is a non-encoded macroblock, an encoded macroblock, which is present in an encoded picture immediately preceding the to-be-encoded picture and which is present at the same spatial position as the macroblock, as the reference macroblock, thereby determining a plurality of reference macroblocks which correspond to the plural peripheral macroblocks;
causing the computer to refer to a cost which indicate a code amount occurring in encoding of each of the determined plural reference macroblocks and which corresponds to each of the plural reference macroblocks, thereby selecting a reference macroblock with a lowest cost of the plural reference blocks, and determining a prediction mode, which is used in the encoding of the selected reference macroblock, as a prediction mode candidate which is to be applied to the to-be-encoded macroblock;
causing the computer to calculate a cost which is indicative of a code amount occurring in a case where the to-be-encoded macroblock is encoded by the determined prediction mode candidate;
causing the computer to determine, if the calculated cost is equal to or less than the cost of the selected reference macroblock, the determined prediction mode candidate as a prediction mode which is to be applied to the to-be-encoded macroblock; and
causing the computer to calculate, if the calculated encoding cost is greater than the encoding cost of the selected macroblock, costs indicative of code amounts which occur in cases where the to-be-encoded macroblock is encoded by prediction modes other than the prediction mode candidate, and to determine a prediction mode with a lowest cost of the prediction modes as a prediction mode which is to be applied to the to-be-encoded macroblock.
